(19) United States
(12) Patent Application Publication
(10) Pub. No.: US 2024/0148215 A1
(43) Pub. Date: May 9, 2024

(54) BASE STATION AND CLEANING ROBOT SYSTEM

(71) Applicant: BEIJING ROBOROCK TECHNOLOGY CO., LTD., Beijing (CN)

(72) Inventors: Xing LI, Beijing (CN); Chuanlin DUAN, Beijing (CN); Pan CHENG, Beijing (CN)

(21) Appl. No.: 18/414,106

(22) Filed: Jan. 16, 2024

Related U.S. Application Data
(63) Continuation of application No. PCT/CN2021/137566, filed on Dec. 13, 2021.

(30) Foreign Application Priority Data
Jul. 16, 2021 (CN) 2021110805968.1

(51) Int. Cl. A47L 11/40; A47L 11/14

(52) U.S. Cl. CPC A47L 11/4091; A47L 11/145; A47L 11/4083; A47L 11/4088; A47L 2201/028

(57) ABSTRACT

The present disclosure relates to the field of smart home technologies and provides a base station and a cleaning robot system. The base station is configured to clean a cleaning system of a cleaning robot and includes a base station body and a cleaning assembly. The cleaning assembly may be movably disposed on the base station body, and includes a first cleaning member and a second cleaning member different from the first cleaning member. The first cleaning member and the second cleaning member remove debris from the cleaning system by interfering with the cleaning system. The first cleaning member and the second cleaning member come into contact with a cleaning mechanism of the cleaning robot through relative movement between the cleaning assembly and the cleaning mechanism after the cleaning assembly faces the cleaning mechanism, such that the debris on the cleaning mechanism may be removed.

### CROSS-REFERENCE TO RELATED APPLICATION

This application is a Continuation Application of PCT International Application No. PCT/CN2021/137566 filed on Dec. 13, 2021, which claims priority to Chinese Patent Application No. 202110805968.1, filed on Jul. 16, 2021, both of which are incorporated herein by reference in their entireties.

### TECHNICAL FIELD

The present disclosure relates to the field of smart home technologies, and in particular relates to a base station and a cleaning robot system.

### BACKGROUND

In the related art, it is usually necessary to clean a cleaning part after a cleaning robot performs a cleaning task. At present, the cleaning part is mostly cleaned manually or directly replaced with a new cleaning part, resulting in great inconvenience in use.

### SUMMARY

The present disclosure provides a base station and a cleaning robot system for automatic cleaning of a cleaning mechanism.

According to an aspect of the present disclosure, a base station is provided. The base station is configured to clean a cleaning system of a cleaning robot and includes:
a base station body; and
a cleaning assembly movably disposed on the base station body and including a first cleaning member and a second cleaning member different from the first cleaning member;
wherein the first cleaning member and the second cleaning member remove debris from the cleaning system by interfering with the cleaning system.

In an embodiment of the present disclosure, the cleaning assembly further includes:
a cleaning assembly holder on which the first cleaning member and the second cleaning member are disposed in parallel.

In an embodiment of the present disclosure, the first cleaning member includes a cleaning roller arranged to rotate relative to the cleaning assembly holder.

In an embodiment of the present disclosure, a brush and/or a blade is disposed on the outer surface of the cleaning roller.

In an embodiment of the present disclosure, the second cleaning member includes a cleaning scraper.

In an embodiment of the present disclosure, the cleaning assembly is configured to move relative to the base station body when the cleaning robot moves to the base station body, wherein
the cleaning roller is configured to interfere with the cleaning system of the cleaning robot during rotation by using the brush and/or the blade disposed on the outer surface; and
the cleaning scraper is configured to interfere with the cleaning system of the cleaning robot during movement relative to the base station body.

In an embodiment of the present disclosure, the cleaning assembly further includes a driving part, the driving part being connected to both the base station body and the cleaning assembly holder to drive the cleaning assembly holder to move relative to the base station body.

In an embodiment of the present disclosure, the driving part is connected to the first cleaning member in a driving manner to drive the first cleaning member to rotate relative to the cleaning assembly holder,
wherein the first cleaning member rotates relative to the cleaning assembly holder when the cleaning assembly holder moves relative to the base station body.

In an embodiment of the present disclosure, the cleaning assembly further includes:
a liquid outlet device, a cleaning liquid discharged by the liquid outlet device being for cleaning the cleaning system of the cleaning robot.

In an embodiment of the present disclosure, the base station body includes a cleaning basin, and the cleaning assembly is located above the cleaning basin,
wherein the cleaning liquid discharged by the liquid outlet device enters the cleaning basin.

In an embodiment of the present disclosure, the cleaning basin is provided with a liquid extracting port through which the cleaning liquid in the cleaning basin may be discharged.

In an embodiment of the present disclosure, the base station body further includes a bottom guiding surface with an anti-skid bulge disposed thereon, and the cleaning robot moves onto the bottom guiding surface along the anti-skid bulge, wherein the cleaning assembly and the anti-skid bulge are spaced apart.

In an embodiment of the present disclosure, the base station body further includes a top guiding surface with a guiding part disposed thereon for being in contact with the cleaning robot,
wherein the guiding part is located above the cleaning assembly.

In an embodiment of the present disclosure, the base station further includes:
a water replenishing connector disposed on the base station body and configured for connection with a liquid storage tank of the cleaning robot, such that the base station supplies a liquid to the liquid storage tank through the water replenishing connector.

According to another aspect of the present disclosure, a cleaning robot system is provided. The cleaning robot system includes the base station described above and a cleaning robot.

For the base station according to embodiments, after the cleaning assembly faces the cleaning mechanism, through relative movement between the cleaning assembly and the cleaning mechanism, the first cleaning member and the second cleaning member come into contact with the cleaning mechanism of the cleaning robot, such that debris on the cleaning mechanism may be removed, namely, the cleaning robot may be cleaned automatically on the cleaning assembly.

### BRIEF DESCRIPTION OF THE DRAWINGS

Various objects, features and advantages of the present disclosure will become more apparent by considering the following detailed descriptions of preferred embodiments of the present disclosure with reference to the accompanying drawings. The accompanying drawings are merely used for schematic illustration of the present disclosure but are not necessarily drawn to scale. In the accompanying drawings, the same reference numbers always indicate the same or similar components, in which:

FIG. 1 is a schematic structural diagram of a cleaning robot in a first posture of a cleaning robot system according to an exemplary embodiment;

FIG. 2 is a schematic structural diagram of a cleaning robot in a second posture of a cleaning robot system according to an exemplary embodiment;

FIG. 3 is a schematic structural diagram of a cleaning robot from a first perspective according to an exemplary embodiment;

FIG. 4 is a schematic structural diagram of a cleaning robot from a second perspective according to an exemplary embodiment;

FIG. 5 is a schematic diagram of a partially exploded structure of a cleaning robot according to an exemplary embodiment;

FIG. 6 is a schematic structural diagram of a cleaning robot from a third perspective according to an exemplary embodiment;

FIG. 7 is a schematic structural diagram of a liquid storage tank of a cleaning robot according to an exemplary embodiment;

FIG. 8 is a schematic structural sectional view of a liquid storage tank of a cleaning robot according to an exemplary embodiment;

FIG. 9 is a schematic structural diagram of a cleaning robot from a fourth perspective according to an exemplary embodiment;

FIG. 10 is a schematic structural diagram of a support platform of a cleaning robot according to an exemplary embodiment;

FIG. 11 is a schematic diagram of a partial structure of a base station according to an exemplary embodiment;

FIG. 12 is a schematic diagram of a partial structure of a base station according to another exemplary embodiment;

FIG. 13 is a schematic diagram of an internal structure of a base station from a first perspective according to an exemplary embodiment;

FIG. 14 is a schematic structural diagram of a base station from a second perspective according to an exemplary embodiment;

FIG. 15A is a schematic diagram of a partial structure of a cleaning assembly of a base station according to an exemplary embodiment;

FIG. 15B is a schematic diagram of a partial structure of a cleaning assembly of a base station according to another exemplary embodiment;

FIG. 15C is a schematic diagram of a partial structure of a cleaning assembly of a base station according to still another exemplary embodiment;

FIG. 15D is a schematic diagram of a partial structure of a cleaning assembly of a base station according to yet another exemplary embodiment;

FIG. 16 is a schematic structural sectional view of a cleaning assembly of a base station according to an exemplary embodiment;

FIG. 17 is a schematic diagram of a separated structure of a liquid storage tank, a water replenishing connector and a first positioning part of a cleaning robot system according to an exemplary embodiment;

FIG. 18 is a schematic structural diagram of a water replenishing connector and a first positioning part of a base station according to an exemplary embodiment;

FIG. 19 is a schematic structural diagram of a base station in one state according to another exemplary embodiment;

FIG. 20 is a schematic structural diagram of a base station in another state according to another exemplary embodiment;

FIG. 21 is a schematic structural diagram of cooperation between a cleaning robot and a base station of a cleaning robot system according to an exemplary embodiment;

FIG. 22 is a local schematic structural diagram of cooperation between a cleaning robot and a base station of a cleaning robot system according to an exemplary embodiment; and

FIG. 23 is a local schematic structural diagram of a base station according to an exemplary embodiment.

Reference numbers in the drawings are described as below:
10—cleaning robot; 110—cleaning robot body; 111—forward portion; 112—rearward portion; 120—perception system; 121—determining device; 122—buffer; 1221—through hole; 130—control module; 140—driving system; 141—driving wheel module; 142—driven wheel; 150—cleaning system; 151—dry cleaning system; 152—side brush; 160—energy system; 170—human-machine interaction system; 400—wet cleaning system; 410—cleaning head; 420—driving unit; 421—driving platform; 422—support platform; 4217—water outlet device; 4218—clean water pump pipe; 4219—clean water pump; 12—first charging contactor; 13—liquid storage tank; 14—second positioning part; 16—water replenishing inlet; 17—valve; 18—pipeline; 19—rotary wheel; 20—base station body; 21—cleaning basin; 211—liquid extracting port; 22—bottom guiding surface; 221—anti-skid bulge; 222—lengthening plate; 23—side guiding surface; 231—lateral surface; 232—middle surface; 24—top guiding surface; 25—guiding press block; 26—guiding wheel; 27—guiding bridge; 30—cleaning assembly; 31—first cleaning member; 311—first rotating shaft; 32—second cleaning member; 33—cleaning assembly holder; 34—driving part; 341—gear; 342—rack; 343—second rotating shaft; 35—liquid outlet; 36—liquid outlet device; 371—first gear; 372—second gear; 373—third gear; 374—fourth gear; 375—fifth gear; 376—sixth gear; 377—seventh gear; 378—eighth gear; 379—ninth gear; 40—second charging contactor; 50—water replenishing connector; 51—body part; 52—sealing part; 53—joint part; 60—first positioning part; 61—accommodating space; 70—liquid supply part; and 71—collection container.

### DETAILED DESCRIPTION

Typical embodiments that embody the features and advantages of the present disclosure will be described in detail in the following description. It should be understood that the present disclosure can have various variations on different embodiments without departing from the scope of the present disclosure, and the descriptions and drawings therein are for the purpose of illustration only, rather than limiting the present disclosure.

Different exemplary embodiments of the present disclosure will be described below with reference to the accompanying drawings, which form a part of the present disclosure and which show, by way of example, different exemplary structures, systems and steps that may implement various aspects of the present disclosure. It should be understood that other specific solutions of components, structures, exemplary devices, systems, and steps are available, and that structural and functional modifications may be made without departing from the scope of the present disclosure. Further, although the terms “above”, “between”, “within”, etc. may be used in the description to describe different exemplary features and elements of the present disclosure, these terms are used herein for convenience only, for example, based on the orientations of the examples in the accompanying drawings. Nothing in the description should be construed as requiring a particular three-dimensional orientation of the structure to fall within the scope of the present disclosure.

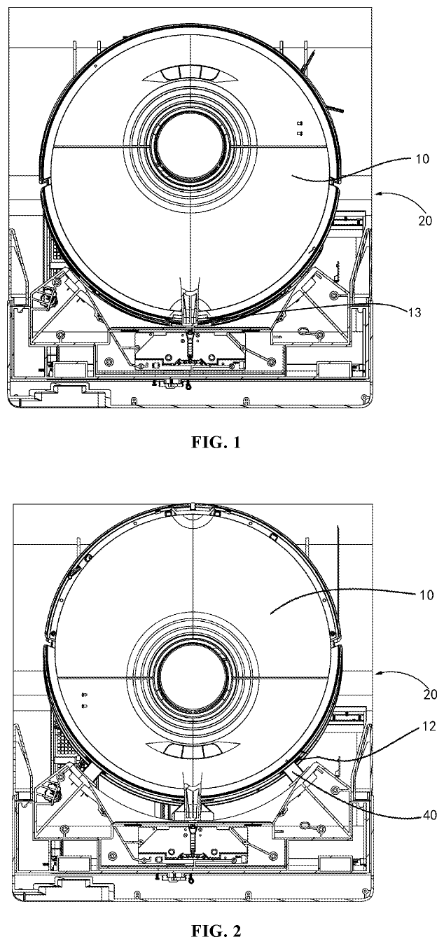

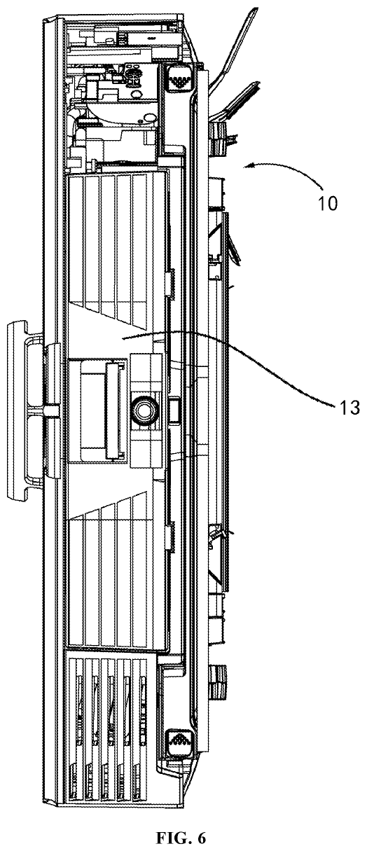

As shown in FIGS. 1 to 23, a cleaning robot system according to embodiments of the present disclosure may include a cleaning robot 10 and a base station.

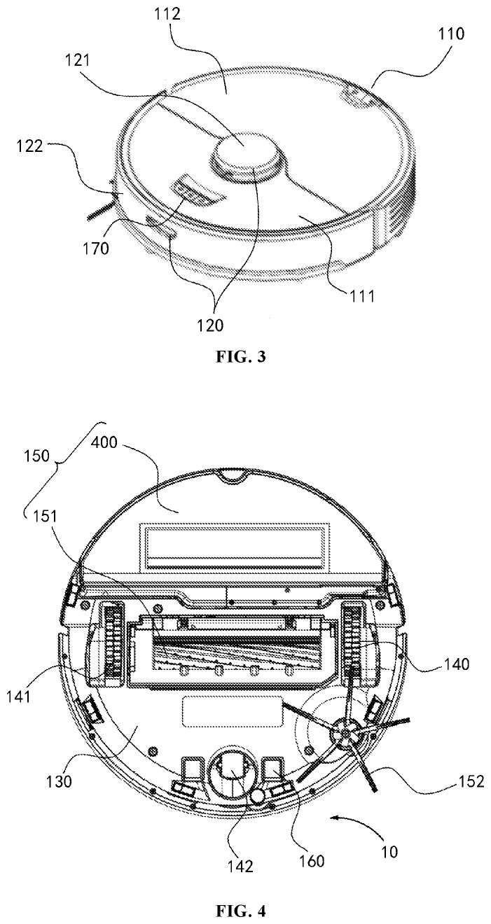

In an embodiment of the present disclosure, as shown in FIGS. 3 and 4, the cleaning robot 10 may include a cleaning robot body 110, a perception system 120, a control module 130, a driving system 140, a cleaning system 150, an energy system 160, and a human-machine interaction system 170.

As shown in FIG. 3, the cleaning robot body 110 includes a forward portion 111 and a rearward portion 112, is approximately circular (having a circular forward portion and rearward portion), and may also take other shapes including, but not limited to, an approximately D shape with a square forward portion and a circular rearward portion, and a rectangular or square shape with a square forward portion and a square rearward portion.

As shown in FIG. 3, the perception system 120 includes a position determining device 121 located on the cleaning robot body 110, a bumping sensor and a proximity sensor both disposed on a buffer 122 of the forward portion 111 of the cleaning robot body 110, a cliff sensor disposed at a lower portion of the cleaning robot body 110, and sensing devices such as a magnetometer, an accelerometer, a gyroscope, and an odometer disposed inside the cleaning robot body, for providing various position information and motion state information of the cleaning for the control module 130. The position determining device 121 includes, but is not limited to, a camera and a laser distance sensor (LDS).

As shown in FIG. 3, the forward portion 111 of the cleaning robot body 110 may bear the buffer 122. The buffer 122 detects one or more events in a travel path of the cleaning robot 10 via a sensor system (for example, an infrared sensor) disposed thereon when a driving wheel module 141 propels the cleaning robot 10 to walk on the floor in the process of cleaning. The cleaning robot 10 may control, based on the events (such as an obstacle and a wall) detected by the buffer 122, the driving wheel module 141 to make the cleaning robot 100 respond to the events, e.g., moving away from the obstacle.

The control module 130 is disposed on a main circuit board in the cleaning robot body 110 and includes a computing processor, such as a central processing unit or an application processor, in communication with a non-transitory memory, such as a hard disk, a flash memory and a random-access memory. The application processor draws a simultaneous map of an environment, where the cleaning robot 10 is located, based on obstacle information fed back by the laser distance sensor by using a positioning algorithm, for example, simultaneous localization and mapping (SLAM). In addition, based on the distance and speed information fed back by the sensors disposed on the buffer 122, the cliff sensor, the magnetometer, the accelerometer, the gyroscope, the odometer, and other sensing devices, a comprehensive judgment may be made on a current working state and a current position of the cleaning robot 10, as well as a current posture of the cleaning robot 10, such as crossing a doorsill, getting on a carpet, at a cliff, being stuck from above or below, having a full dust box, being picked up, etc. For different cases, specific next action strategies may be provided such that the cleaning robot 10 has better cleaning performance and user experience.

As shown in FIG. 4, the driving system 140 may control the cleaning robot body 110 to travel across the floor based on a driving command with distance and angle information (e.g., x, y, and θ components). The driving system 140 includes the driving wheel module 141 that may control both a left wheel and a right wheel simultaneously. For more precise control of the movement of the cleaning robot, the driving wheel module 141 may include a left driving wheel module and a right driving wheel module, which are arranged along a transverse axis defined by the cleaning robot body 110. The cleaning robot 10 may include one or more driven wheels 142, which include but are not limited to universal wheels, in order to enable the cleaning robot 10 to move more stably on the floor or have a better movement ability. The driving wheel module includes a traveling wheel, a driving motor, and a control circuit for controlling the driving motor, and may also be connected to a circuit for measuring a driving current, and an odometer. The driving wheel module 141 may be detachably connected to the cleaning robot body 110 to facilitate disassembly, assembly and maintenance. The driving wheel may be provided with an offset drop suspension system, which is fastened movably to (e.g., attached rotatably to) the cleaning robot body 110, and receives a spring offset biased downward and away from the cleaning robot body 110. The spring offset allows the driving wheel to maintain contact and traction with the floor with a certain ground adhering force, while cleaning elements of the cleaning robot 100 are also in contact with the floor with certain pressure.

The energy system may include a rechargeable battery, such as a Ni-MH battery and a lithium battery. The rechargeable battery may be connected to a charging control circuit, a battery pack charging temperature detecting circuit, and a battery undervoltage monitoring circuit which are then connected to a single chip microcomputer control circuit. A host is connected to a charging pile through a charging electrode disposed on one side or below the cleaning robot body for charging.

The human-computer interaction system 170 may include buttons on a panel of the host for a user to select functions, and may further include a display screen and/or an indicator light and/or a speaker, as well as a mobile phone client program. The display, the indicator light and the speaker show the user the current state or function options of the cleaning robot. For a route navigation type automatic cleaning apparatus, a mobile phone client may show the user a map of the environment where the apparatus is located, as well as a position of the apparatus, thereby providing the user with richer and more user-friendly function items.

The cleaning system may be a dry cleaning system 151 and/or a wet cleaning system 400.

As shown in FIG. 4, the dry cleaning system 151 provided by the embodiment of the present disclosure may include a roller brush, a dust box, a fan, and an air outlet. The roller brush with certain interference with the floor sweeps up debris on the floor and rolls up it to the front of a dust suction inlet between the roller brush and the dust box, and then the debris is sucked into the dust box by a gas with a suction force, which is generated by the fan and passes through the dust box. The dust removal capacity of the cleaning robot 10 can be characterized by the dust pickup (DPU) efficiency of the debris, which is affected by the structure and the material of the roller brush, the utilization rate of air in an air passage formed by the dust suction inlet, the dust box, the fan, the air outlet and connecting parts among the dust suction inlet, the dust box, the fan and the air outlet, and the type and the power of the fan, and thus is a complex problem of system design. The improvement of dust removal capacity is of greater significance to the energy-limited automatic cleaning apparatus than an ordinary plug-in vacuum cleaner. This is because the improvement of the dust removal capacity directly and effectively reduces the demand for energy, i.e., an original cleaning apparatus capable of cleaning 80 square meters of the floor with one charge may be improved to clean 180 square meters or more with one charge. In addition, the service life of a battery with a reduced number of charging times may be greatly prolonged, such that the frequency of replacing the battery by the user may be reduced. More intuitively and importantly, the improvement of the dust removal capacity is the most obvious and important user experience as the user can directly draw a conclusion about whether the thorough sweeping/mopping is achieved. The dry cleaning module may further include a side brush 152 provided with a rotating shaft angled with respect to the floor, for moving the debris into a roller brush area of the cleaning system 150.

As shown in FIGS. 4 to 8, the wet cleaning system 400 provided by the embodiment of the present disclosure may include a cleaning head 410, a driving unit 420, a water delivery mechanism, a liquid storage tank 13, and the like. The cleaning head 410 may be disposed below the liquid storage tank 13. A cleaning liquid in the liquid storage tank 13 may be delivered to the cleaning head 410 by the water delivery mechanism, such that a surface to be cleaned may be subjected to wet cleaning by the cleaning head 410. In other embodiments of the present disclosure, the cleaning liquid in the liquid storage tank 13 may also be directly sprayed onto the surface to be cleaned, and the cleaning head 410 may clean the surface by evenly applying the cleaning liquid.

The cleaning head 410 is configured to clean the surface to be cleaned, and the driving unit 420 is configured to drive the cleaning head 410 to substantially reciprocate along a target surface that is a part of the surface to be cleaned. The cleaning head 410 reciprocates along the surface to be cleaned, and a surface of the cleaning head 410 in contact with the surface to be cleaned is provided with a cleaning cloth or a cleaning pad, which generates a high-frequency friction with the surface to be cleaned through a reciprocating motion thereof, thereby removing stains on the surface to be cleaned.

The higher the friction frequency is, the larger the number of friction times per unit time is. A high-frequency reciprocating motion, also known as reciprocating vibration, has a cleaning ability much higher than that of an ordinary reciprocating motion, such as rotational friction cleaning. Optionally, the friction frequency is approximate to the frequency of sound waves, and the cleaning effect may be much higher than that of rotational friction cleaning with dozens of revolutions per minute. On the other hand, tufts on the surface of the cleaning head may spread more neatly in the same direction under shaking of high-frequency vibration, such that the overall cleaning effect is more uniform, rather than that under the condition of low-frequency rotation, only downward pressure is applied to increase a friction force to improve the cleaning effect since the downward pressure alone may not make the tufts spread in approximately the same direction. Therefore, in terms of the effect, water marks on the surface to be cleaned that are cleaned by high-frequency vibration are more uniform, and no chaotic water stains will be left.

The reciprocating motion may be a repeated motion along any one or more directions within the surface to be cleaned, or may be a vibrating motion perpendicular to the surface to be cleaned, which is not strictly limited. Optionally, the reciprocating direction of the cleaning module is substantially perpendicular to the travelling direction of the cleaning robot because the reciprocating direction being parallel to the travelling direction of the cleaning robot may cause the cleaning robot itself, which is traveling, to be unstable for the reason that thrust and resistance in the travelling direction make it easy for the driving wheel to skid, and the impact of skid is more obvious when the wet cleaning module is included as the wetness of the surface to be cleaned increases the possibility of skid. The skid not only adversely affects smooth travelling of the cleaning robot for cleaning, but also leads to inaccurate distance measurement by the odometer, the gyroscope and other sensors, and thus disables the navigation-type automatic cleaning apparatus from accurately locating and drawing maps. In the case of frequent skid, the impact on SLAM may not be ignored, so it is necessary to prevent the cleaning robot from skidding as much as possible. In addition to skid, a motion component of the cleaning head 410 in the travelling direction of the cleaning robot causes the cleaning robot to be constantly pushed forward and backward when the cleaning robot travels, and as a result, the cleaning robot may travel unstably.

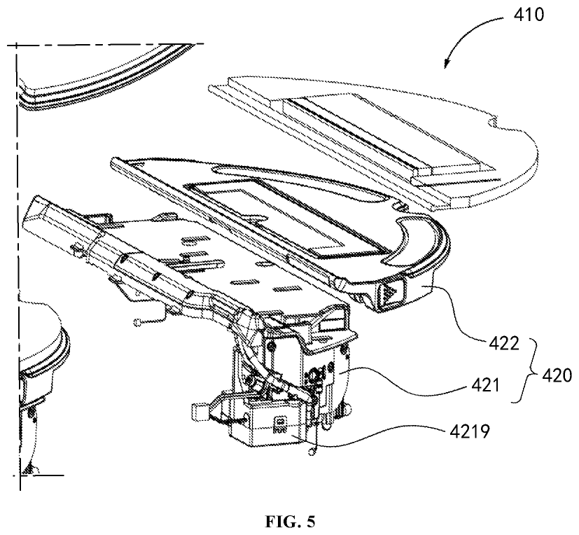

In an embodiment of the present disclosure, as shown in FIG. 5, the driving unit 420 may further include: a driving platform 421 connected to the bottom surface of the cleaning robot body 110 and configured to provide a driving force; and a support platform 422 detachably connected to the driving platform 421, configured to support the cleaning head 410 and being able to ascend and descend under the driving of the driving platform 421.

As an alternative embodiment of the present disclosure, the wet cleaning system 400 may be connected to the cleaning robot body 110 by an active lifting module. When the wet cleaning system 400 is temporarily not involved in the work, for example, when the cleaning robot 10 stops at the base station for cleaning the cleaning head 410 of the wet cleaning system 400 and for injecting water into the liquid storage tank; or when the cleaning robot 10 encounters a surface to be cleaned that cannot be cleaned by the wet cleaning module 400, the wet cleaning system 400 is lifted up by means of the active lifting module.

In the wet cleaning system 400 provided by the embodiment of the present disclosure, the cleaning head 410, the driving platform 421, the support platform 422, the water delivery mechanism, the liquid storage tank 13 and the like may be powered by one or one motors. The energy system 160 provides power and energy for the motor and is controlled by the control module 130 as a whole.

The water delivery mechanism in the embodiment of the present disclosure may include a water outlet device. The water outlet device may be directly or indirectly connected to a liquid outlet of the liquid storage tank 13. As shown in FIG. 10, a cleaning liquid may flow toward the water outlet device 4217 via a cleaning liquid outlet of the liquid storage tank, and may be evenly applied by the water outlet device to the surface to be cleaned. The water outlet device may be provided with a connecting member by which the water outlet device is connected to the cleaning liquid outlet of the liquid storage tank. The water outlet device is provided with a dispensing port. The dispensing port may be a continuous opening, or a combination of several discontinuous small openings. A plurality of nozzles may be provided at the dispensing port. The cleaning liquid flows toward the dispensing port via the cleaning liquid outlet of the liquid storage tank and the connecting member of the water outlet device, and is evenly applied, via the dispensing port, to the surface to be cleaned.

As shown in FIGS. 5 and 10, the water delivery mechanism may further include a clean water pump 4219 and/or a clean water pump pipe 4218. The clean water pump 4219 may be communicated with the cleaning liquid outlet of the liquid storage tank directly or by the clean water pump pipe 4218.

The clean water pump 4219 may be connected to the connecting member of the water outlet device, and configured to pump the cleaning liquid from the liquid storage tank to the water outlet device. The clean water pump may be a gear pump, a blade pump, a plunger pump, a peristaltic pump, or the like.

The water delivery mechanism draws the cleaning liquid from the liquid storage tank through the clean water pump 4219 and the clean water pump pipe 4218, and transports the cleaning liquid to the water outlet device. The water outlet device 4217 may be a sprinkler head, a drip hole, a wet cloth, or the like, and may spread water evenly on the cleaning head 410 so as to wet the cleaning head 410 and the surface to be cleaned. Therefore, stains on the wetted surface to be cleaned may be cleaned more easily. In the wet cleaning system 400, the power/flow rate of the clean water pump may be adjusted.

In an embodiment of the present disclosure, the liquid storage tank 13 may further include a water replenishing inlet 16, as shown in FIGS. 7 to 9. The water replenishing inlet 16 may be located on a side wall of the liquid storage tank, and the base station may inject water into the liquid storage tank 13 of the cleaning robot 10 through the water replenishing inlet 16 when the cleaning robot 10 stops at the base station.

In an embodiment of the present disclosure, as shown in FIG. 7, the liquid storage tank 13 may be provided with a second positioning part 14, and the second positioning part 14 is configured for being connected with the base station, such that the base station may inject water into the liquid storage tank 13 of the cleaning robot 10 through the water replenishing inlet 16.

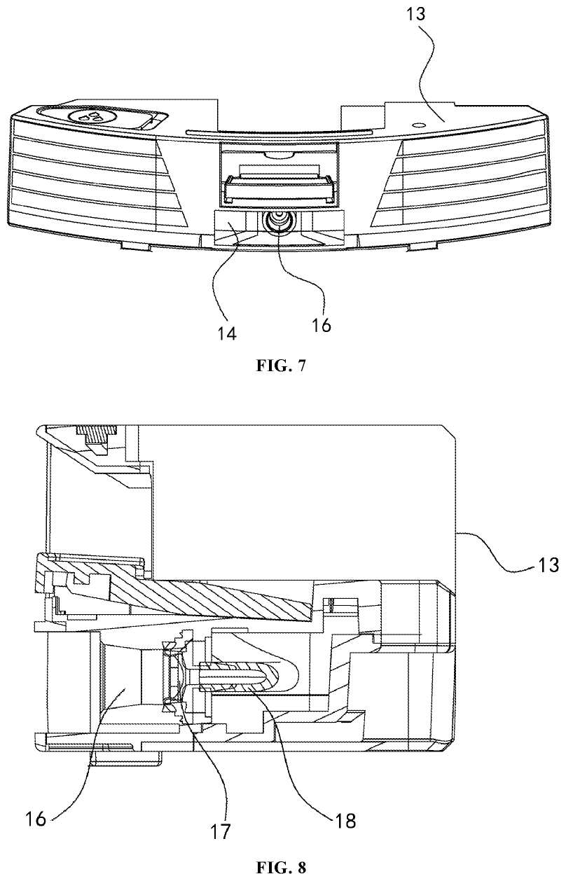

In an embodiment of the present disclosure, as shown in FIG. 8, the water replenishing inlet 16 of the liquid storage tank 13 may be provided with a valve 17, and the valve 17 may be opened and closed to control the water replenishing inlet 16 to be communicated with or disconnected from the liquid storage tank 13. A pipeline 18 with the valve 17 disposed at one end thereof is disposed in the liquid storage tank 13.

In an embodiment of the present disclosure, the valve 17 may be an electronic valve or a manual valve, and may be opened or closed through corresponding control. In other embodiments of the present disclosure, the valve 17 may also be a check valve. After liquid replenishing of the liquid storage tank 13 is completed and the water replenishing inlet 16 is disconnected from the liquid storage tank 13, the valve 17 is automatically closed to prevent the cleaning liquid in the liquid storage tank 13 from flowing out. For example, the valve 17 may be a cross valve, a lift check valve, a swing check valve, etc.

In an embodiment of the present disclosure, the cleaning robot 10 further includes a first charging contactor 12 that may be provided on the cleaning robot body 110 and connected to the energy system of the cleaning robot 10. The base station may charge the energy system of the cleaning robot 10 by the first charging contactor 12 when the cleaning robot 10 stops at the base station. In an embodiment of the present disclosure, the first charging contactor 12 may be located on a side surface of the body of the cleaning robot 10, and with this arrangement, the first charging contactor 12 can be prevented from being contaminated by water accumulated on the floor, and the following situation is avoided: the charging contactor contacts water when the cleaning robot 10 stops at the base station for injecting water into the liquid storage tank 13 or for cleaning the cleaning system 150 of the cleaning robot 10 to cause damage to the cleaning robot 10.

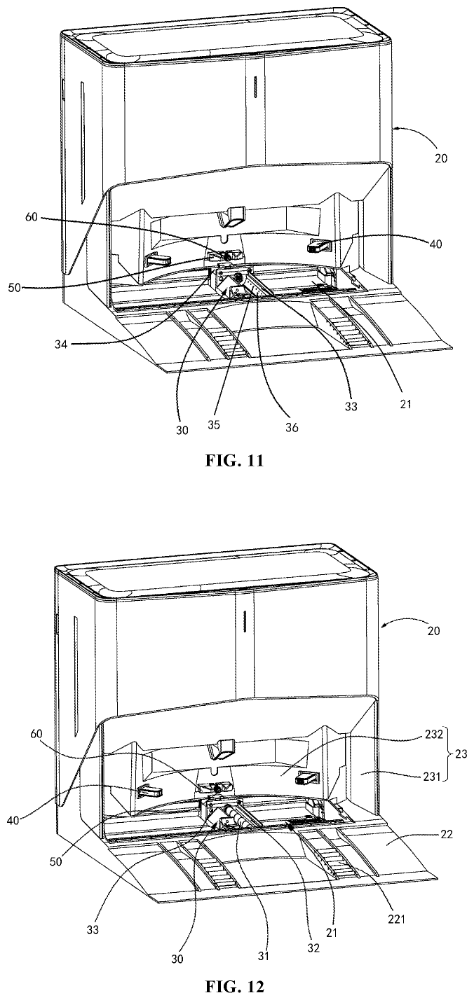

In an embodiment of the present disclosure, as shown in FIGS. 11 and 12, the base station may include a base station body 20 and a cleaning assembly 30. The cleaning assembly 30 may be movably disposed on the base station body 20, and includes a first cleaning member 31 and a second cleaning member 32 different from the first cleaning member 31. The first cleaning member 31 and the second cleaning member 32 remove debris from the cleaning system 150 by interfering with the cleaning system 150.

In an embodiment of the present disclosure, the cleaning assembly 30 faces the cleaning system 150 when the cleaning robot 10 moves to the base stations body 20. The cleaning assembly 30 moves relative to the base station body 20, such that the first cleaning member 31 and the second cleaning member 32 remove the debris from the cleaning system 150 by interfering with the cleaning system 150, i.e., the cleaning robot 10 may be automatically cleaned on the cleaning assembly 30.

In an embodiment of the present disclosure, as shown in FIG. 11 and FIG. 12, the cleaning assembly 30 further includes a cleaning assembly holder 33 movably disposed on the base station body 20. The first cleaning member 31 and the second cleaning member 32 are disposed on the cleaning assembly holder 33, that is, the cleaning assembly holder 33 acts as a movable part to ensure that the first cleaning member 31 and the second cleaning member 32 may move with it, thereby ensuring that the first cleaning member 31 and the second cleaning member 32 interfere with different positions of the cleaning system 150 to guarantee the cleaning effect.

In an embodiment of the present disclosure, the first cleaning member 31 and the second cleaning member 32 are disposed in parallel on the cleaning assembly holder 33. The second cleaning member 32 may be disposed on either side of the first cleaning member 31 in parallel. If there is a plurality of second cleaning members 32, the second cleaning members 32 may be distributed on either side or both sides of the first cleaning member 31 in parallel.

In an embodiment of the present disclosure, the first cleaning member 31 includes a cleaning roller arranged to rotate relative to the cleaning assembly holder 33. A brush and/a blade is disposed on the outer surface of the cleaning roller. The second cleaning member 32 includes a cleaning scraper.

In an embodiment of the present disclosure, the cleaning assembly 30 is configured to move relative to the base station body 20 when the cleaning robot 10 moves to the base station body 20. The cleaning roller is configured to interfere with the cleaning system 150 of the cleaning robot 10 during rotation by using the brush and/or blade provided on the outer surface. The cleaning scraper is configured to interfere with the cleaning system 150 of the cleaning robot 10 during movement relative to the base station body 20.

In an embodiment of the present disclosure, as stated above, the cleaning system 150 of the cleaning robot 10 may include the dry cleaning system 151 and the wet cleaning system 400. The process of cleaning the wet cleaning system 400 of the cleaning robot 10 by the cleaning assembly 30 of the base station will be described in detail below.

As shown in FIG. 1, the wet cleaning system 400 of the cleaning robot 10 is fixed relative to the base station body 20 when the cleaning robot 10 moves onto the base station body 20. The cleaning assembly 30 of the base station is in contact with the cleaning head 410 of the wet cleaning system 400 of the cleaning robot 10. In other embodiments of the present disclosure, the wet cleaning system 400 of the cleaning robot 10 may move vertically by means of the active lifting module. Therefore, when the cleaning robot 10 stops at the base station for cleaning operations, the active lifting module may be adjusted to achieve better contact between the cleaning assembly 30 of the base station and the cleaning head 410 of the wet cleaning system 400 of the cleaning robot 10. For example, in an embodiment of the present disclosure, the wet cleaning system 400 of the cleaning robot 10 may be cleaned when completely lifted up. In other embodiments of the present disclosure, the wet cleaning system 400 of the cleaning robot 10 may also be cleaned in other lifting states. The lifting state of the wet cleaning system 400 may be adjusted according to the material of the cleaning head 410 of the wet cleaning system 400. For example, in the case of a small coefficient of friction of the cleaning head 410 to be cleaned, the contact between the cleaning head 410 and the cleaning assembly 30 may be closer to ensure that a friction force between the cleaning head 410 and the cleaning assembly 30 falls within a certain range when the cleaning assembly 30 moves relative to the base station body 20, thereby facilitating smooth cleaning; and vice versa. In addition, the lifting state of the wet cleaning system 400 may be adjusted according to the dirtiness of the cleaning head 410 of the wet cleaning system 400. For example, in the case that the cleaning head 410 needing to be cleaned is relatively dirty, the contact between the cleaning head 410 and the cleaning assembly 30 may be made closer to produce a large friction force between the cleaning head 410 and the cleaning assembly 30, so as to guarantee that the debris on the cleaning head 410 can be effectively removed; and vice versa. In an embodiment of the present disclosure, the lifting state of the wet cleaning system 400 may be adjusted by a user according to actual situations, or a sensor may be disposed in a specific position, for example, on the cleaning head 410 of the wet cleaning system 400, and outputs a specific signal to the control module 130 of the cleaning robot 10, and the control module 130 automatically adjusts the lifting state of the wet cleaning system 400 according to a feedback result from the sensor. In other embodiments of the present disclosure, the lifting state of the wet cleaning system 400 may also be adjusted in other ways, which is not limited by the present disclosure. In other embodiments of the present disclosure, a better contact between the cleaning assembly 30 and the cleaning head 410 of the wet cleaning system 400 of the cleaning robot 10 may also be realized by adjusting the lifting state of the cleaning assembly 30, which is not limited by the present disclosure.

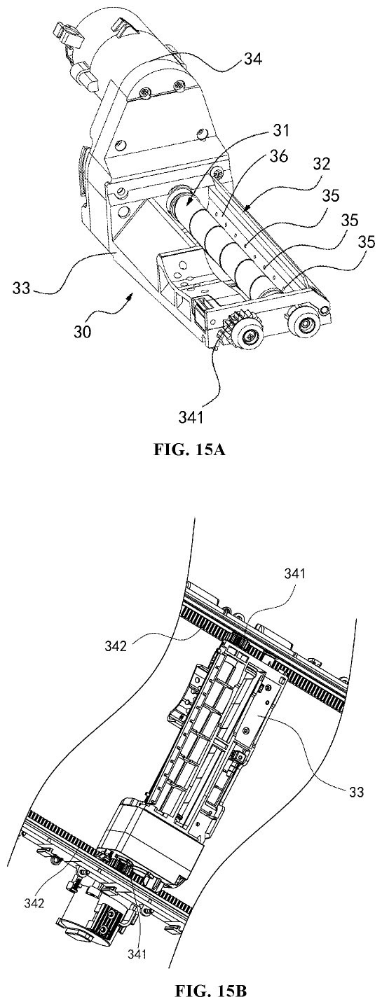

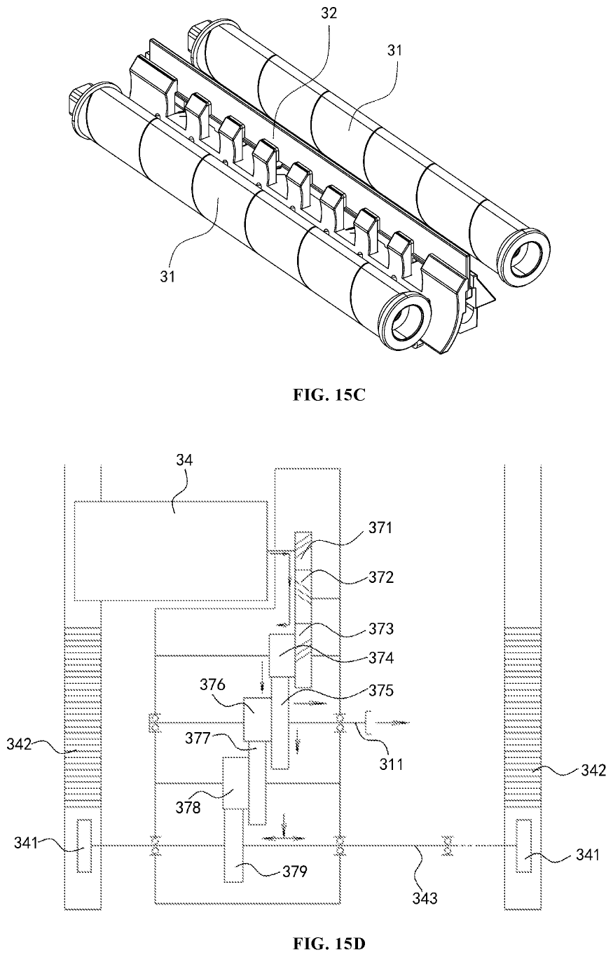

When the cleaning robot 10 is fixed to the base station body 20 and the cleaning head 410 of the wet cleaning system 400 of the cleaning robot 10 is in better contact with the cleaning assembly 30 of the base station, the cleaning assembly 30 may clean the wet cleaning system 400 of the cleaning robot 10. In an embodiment of the present disclosure, as shown in FIG. 15A, the cleaning assembly 30 includes a first cleaning member 31 of a roller structure and a second cleaning member 32 of a scraper structure. In other embodiments of the present disclosure, the cleaning assembly may further include a liquid outlet device 36. In the process of cleaning the wet cleaning system 400 of the cleaning robot 10 by the cleaning assembly 30, the liquid outlet device of the cleaning assembly 30 may work simultaneously to spray the cleaning liquid onto the first cleaning member 31, and the first cleaning member 31 evenly applies the cleaning liquid to the cleaning head 410 of the wet cleaning system 400 by contact with the cleaning head 410 of the wet cleaning system 400 of the cleaning robot 10 and by its own rotation. In addition, the first cleaning member 31 may be a brush roller or a soft rubber roller with a blade, and the cleaning head 410 of the wet cleaning system 400 of the cleaning robot 10 may be made of fiber or cotton soft cloth, or sponge, or the like. In the cleaning process, bristles or the blades of the first cleaning member 31 may stretch into and be in sufficient contact with the cleaning head 410, and take debris out of the cleaning head 410 of the wet cleaning system 400. Moreover, the first cleaning member 31 may rotate while moving left and right, and its bristles or blades may pat the cleaning head 410 of the wet cleaning system 400 during the rotation, such that the debris hidden inside the cleaning head 410 may be shaken out and scraped off under the vibration generated by the patting effect. At the same time, in cooperation with the work of the first cleaning member 31, a scraper of the second cleaning member 32 removes the debris brought out or shaken out of the cleaning head 410 of the wet cleaning system 400, as well as sewage on the cleaning head 410. In other embodiments of the present disclosure, the first cleaning member 31 may rotate in different directions while moving left and right. For example, the first cleaning member 31 may rotate clockwise while moving left relative to the base station body 20; and the first cleaning member 31 may rotate counterclockwise while moving right relative to the base station body 20.

As previously described, the wet cleaning system 400 of the cleaning system 150 may reciprocate relative to the base station body 20. In an embodiment of the present disclosure, during the movement of the cleaning assembly 30 relative to the base station body 20, the wet cleaning system 400 of the cleaning robot 10 may remain stationary or reciprocate correspondingly to cooperate with the movement of the cleaning assembly 30 so as to ensure quick cleaning of the wet cleaning system 400. For example, in the case that the cleaning assembly 30 moves left relative to the base station body 20, the wet cleaning system 400 of the cleaning robot 10 may move right relative to the base station body 20 so as to increase the speed of relative movement between the cleaning assembly 30 and the wet cleaning system 400 and improve the cleaning efficiency; and vice versa.

In an embodiment of the present disclosure, the first cleaning member 31 and the second cleaning member 32 are provided synchronously movably.

As shown in FIG. 15A, the first cleaning member 31 and the second cleaning member 32 are both disposed on the cleaning assembly holder 33 of the cleaning assembly 33, such that the cleaning assembly holder 33 drives the first cleaning member 31 and the second cleaning member 32 to move synchronously in the same direction, and hence the cleaning system 150 is cleaned by the first cleaning member 31 and the second cleaning member 32 sequentially. In other embodiments of the present disclosure, the first cleaning member 31 and the second cleaning member 32 may be disposed on different holders, and in this arrangement, the movements of the first cleaning member 31 and the second cleaning member 32 may be controlled by controlling the movements of the holders respectively, and hence the first cleaning member 31 and the second cleaning member 32 may move asynchronously. For example, the first cleaning member 31 or the second cleaning member 32 may work alone; or, according to actual situations, there may be a time difference when the first cleaning member 31 and the second cleaning member 32 clean the same position of the cleaning head 410, which is not limited by the present disclosure.

As previously described, the cleaning assembly 30 may include one or more first cleaning members 31 and second cleaning members 32. For example, in an embodiment of the present disclosure, the cleaning assembly 30 may include two first cleaning members 31 and one second cleaning member 32. The first cleaning members 31 are disposed at two sides of the second cleaning member 32 respectively, as shown in FIG. 15C. In this embodiment, the first cleaning members 31 may be always in front of the second cleaning member 32 in the reciprocating process of the cleaning assembly 30. Owing to this arrangement, in the process of cleaning the cleaning head 410 of the wet cleaning system 400 of the cleaning robot by the cleaning assembly 30, the first cleaning members 31 may first clean a part to be cleaned of the cleaning head 410, namely, the bristles or blades of the first cleaning members 31 produce a patting effect on the cleaning head 410 during rotation of the first cleaning members 31, causing the debris hidden inside the cleaning head 410 to be shaken out or removed by scraper under the vibration generated by the patting effect; and subsequently, the scraper of the second cleaning member 32 removes the debris brought or shaken out of the cleaning head 410, as well as the sewage on the cleaning head 410 to ensure that the cleaning head 410 may be cleaned more thoroughly.

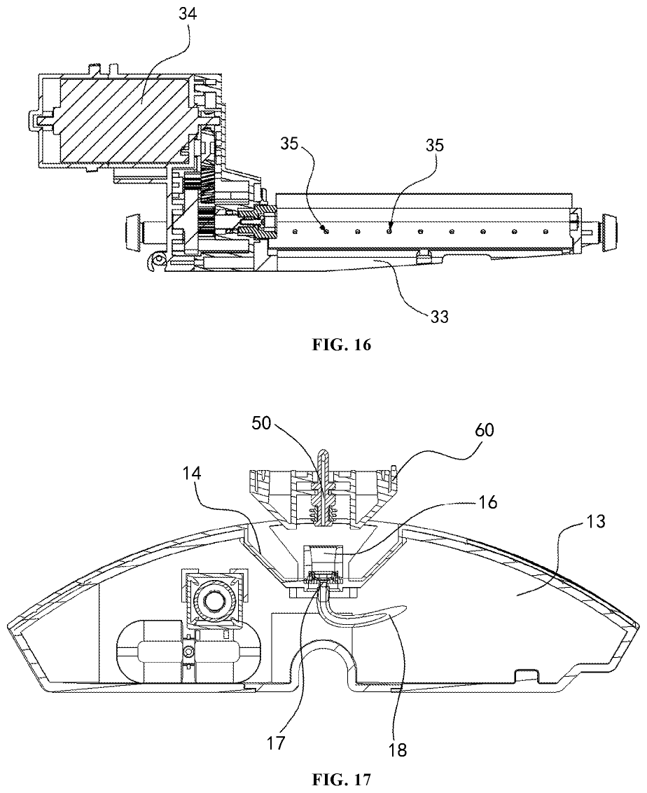

In an embodiment of the present disclosure, as shown in FIGS. 15A and 16, the cleaning assembly 30 further includes a driving part 34, and the driving part 34 is connected to the cleaning assembly holder 33 and the base station body 20 to drive the cleaning assembly holder 33 to move relative to the base station body 20.

Optionally, as shown in FIGS. 15A and 15B, the driving part 34 and the cleaning assembly holder 33 synchronously move relative to the base station body 20. That is, the driving part 34 may include a motor and a gear 341, and the motor drives the gear 341 to rotate; and the base station body 20 may be provided with a rack 342, and the gear 341 may move in an extending direction of the rack 342, such that the driving part 34 and the cleaning assembly holder 33 synchronously move on the base station body 20. Optionally, the racks 342 are provided at two end sides of the cleaning assembly holder 33 respectively, there may be at least two gears 341 correspondingly, and the at least two gears 341 are meshed with the two racks 342 respectively.

In addition, as stated above, the first cleaning member 31 of the cleaning assembly 30 may rotate when the cleaning assembly 30 moves relative to the base station body 20. The driving part 34 is connected to the first cleaning member 31 in a driving manner to drive the first cleaning member 31 to rotate relative to the cleaning assembly holder 33. The first cleaning member 31 rotates relative to the cleaning assembly holder 33 when the cleaning assembly holder 33 moves relative to the base station body 20. In an embodiment of the present disclosure, the same motor may be used to simultaneously drive the cleaning assembly 30 to move relative to the base station body 20 and the first cleaning member 31 to rotate. Specifically, an output shaft of the motor is connected to the gear 341 and the first cleaning member 31 by a gear transmission assembly, such that when running, the motor may simultaneously drive the gear 341 and the first cleaning member 31 to rotate. At this time, the gear 341 moves in the extending direction of the rack, while the first cleaning member 31 rotates. The gear transmission assembly is configured according to actual requirements on the speed of rotation, which is not limited herein. The gear transmission assembly includes a gear and a connecting shaft and may further include a conveyor belt, a chain, or the like, which is not limited herein so long as the motor can simultaneously drive the gear 341 and the first cleaning member 31 to rotate. In some embodiments of the present disclosure, it is not excluded that two motors are employed, namely, one motor is employed to drive the cleaning assembly 30 to move relative to the base station body 20 and the other motor is employed to drive the first cleaning member 31 to rotate.

Optionally, the driving part 34 may be secured to the base station body 20 and may be an air cylinder or an oil cylinder, and a telescopic rod of the driving part 34 is connected to the cleaning assembly holder 33, such that the cleaning assembly holder 33 is driven to move on the base station body 20 by extension and retraction of the telescopic rod. In other embodiments of the present disclosure, the driving part 34 may also be an electric cylinder, or a combination of a motor and a conveyor belt, which is not limited by the present disclosure so long as the cleaning assembly holder 33 can be driven to move. As stated above, the first cleaning member 31 and the second cleaning member 32 in the embodiment of the present disclosure may be located on different holders to realize asynchronous movement. For this reason, the holder of each of the first cleaning member 31 and the second cleaning member 32 may be provided with a separate driving part, which is not limited by the present disclosure.

In an embodiment of the present disclosure, the left-right movement of the cleaning assembly 30 relative to the base station body 20 and the rotation of the first cleaning member 31 are driven by the same driving part, as shown in FIG. 15D. In this embodiment, the left-right movement of the cleaning assembly 30 and the rotation of the first cleaning member 31 are realized by the driving part 34 in cooperation with multi-stage gears. In this embodiment, the driving part 34 may be a motor, the cleaning assembly 30 may further include a gear transmission assembly, and the first cleaning member 31 rotates while the motor drives the cleaning assembly holder 33 to move by the gear transmission assembly, i.e., the gear 341 and the first cleaning member 31 are driven to rotate synchronously.

As shown in FIG. 15D, the gear transmission assembly includes a first gear 371, a second gear 372, a third gear 373, a fourth gear 374, a fifth gear 375, a sixth gear 376, a seventh gear 377, an eighth gear 378, and a ninth gear 379. The motor is connected to the first gear 371. The first gear 371 is meshed with the second gear 372. The second gear 372 is meshed with the third gear 373, and is located between the first gear 371 and the third gear 373, such that the first gear 371 drives the third gear 373 to rotate by the second gear 372 when the motor drives the first gear 371 to rotate. The fourth gear 374 is connected to the third gear 373, and the fourth gear 374 and the third gear 373 are provided coaxially, such that the third gear 373 drives the fourth gear 374 to rotate synchronously. The fourth gear 374 is meshed with the fifth gear 375 to drive the fifth gear 375 to rotate. The sixth gear 376 is connected to the fifth gear 375, and the sixth gear 376 and the fifth gear 375 are provided coaxially, such that the fifth gear 375 may drive the sixth gear 376 to rotate synchronously, and a first rotating shaft 311 connected to the sixth gear 376 and the fifth gear 375 drives the first cleaning member 31 to rotate. The sixth gear 376 is meshed with the seventh gear 377 to drive the seventh gear 377 to rotate. The eighth gear 378 is connected to the seventh gear 377, and the eighth gear 378 and the seventh gear 377 are provided coaxially, such that the seventh gear 377 may drive the eighth gear 378 to rotate coaxially. The eighth gear 378 is meshed with the ninth gear 379 to drive the ninth gear 379 to rotate, and a second rotating shaft 343 connected to the ninth gear 379 drives the gear 341 provided thereon to rotate, thereby causing the gear 341 to move along the rack 342.

In this embodiment, the motor may rotate forward and reversely, thus may drive the cleaning assembly holder 33 to move in two opposite directions, and at the same time, may drive the first cleaning member 31 to rotate in two directions (i.e., clockwise and anticlockwise). For example, the motor may drive the first cleaning member 31 to rotate clockwise while driving the cleaning assembly holder 33 to move left relative to the base station body 20; and the motor may also drive the first cleaning member 31 to rotate counterclockwise while driving the cleaning assembly holder 33 to move right relative to the base station body 20. It should be noted that the types or the sizes of the aforementioned gears are not limited herein, and can be correspondingly selected according to actual needs.

In other embodiments of the present disclosure, the cleaning assembly 30 may also be provided according to the shape of an object to be cleaned. As shown in FIG. 5, the cleaning head 410 of the wet cleaning system 400 of the cleaning robot 10 is shaped like a fan. In order to improve the cleaning efficiency, the motion mode of the cleaning assembly 30 may be set to be similar to that of a wiper brush, namely, one end of the cleaning assembly 30 is fixed to the base station body 20, and the other end thereof may reciprocate around the fixed end, which is not limited by the embodiment of the present disclosure.

The base station body 20 includes a cleaning basin 21. The cleaning assembly 30 includes a liquid outlet device 36. A cleaning liquid discharged by the liquid outlet device 36 is used for cleaning the cleaning system 150 of the cleaning robot 10 and enters the cleaning basin 21. The cleaning assembly 30 is located above the cleaning basin 21.

In an embodiment of the present disclosure, the liquid outlet device 36 of the base station is movably disposed to spray or apply the cleaning liquid onto the cleaning system 150 of the cleaning robot 10 more evenly, so that it may be ensured that the cleaning system 150 is punctually wetted by the cleaning liquid when the cleaning system 150 of the cleaning robot 10 is cleaned by the cleaning assembly 30.

In addition, while the cleaning system 150 is cleaned, the following situation is avoided: the cleaning liquid overflows into an external environment or flows into relevant power components of the cleaning robot 10 to result in safety problems.

In an embodiment of the present disclosure, in the case that the cleaning robot 10 stops at the base station body 20 and remains stationary, the cleaning assembly 30 is in contact with the cleaning system 150 of the cleaning robot 10 and moves relative to the base station body 20 and the cleaning robot 10, and the cleaning liquid discharged by the liquid outlet device 36 wets the cleaning system 150 of the cleaning robot 10, such that the cleaning system 150 of the cleaning robot 10 can be effectively cleaned.

It should be noted that when the cleaning assembly 30 of the base station moves, the cleaning liquid discharged by the liquid outlet device 36 may be used for cleaning the cleaning system 150 of the cleaning robot 10, namely, the debris on the cleaning system 150 of the cleaning robot 10 may be removed with the help of the cleaning liquid. Therefore, the cleaning system 150 is uniformly wetted during the movement of the liquid outlet device 36.

In an embodiment of the present disclosure, as shown in FIG. 12, the liquid outlet device 36 is disposed on the cleaning assembly holder 33, namely, the cleaning assembly holder 33 is used as a movable part to ensure that the liquid outlet device 36 may move with it so as to guarantee that the cleaning liquid is discharged from different positions to evenly wet the object to be cleaned. In an embodiment of the present disclosure, the base station further includes a liquid feeding channel, one end of which is communicated with a liquid supply part 70, and the other end of which is communicated with the liquid outlet device 36, such that the liquid supply part 70 may feed the cleaning liquid into the liquid outlet device 36 through the liquid feeding channel. At least part of the liquid feeding channel is movably disposed along with the cleaning assembly holder 33. The liquid supply part 70 realizes the storage of the cleaning liquid, and the liquid feeding channel serves as a transport component to move with the cleaning assembly holder 33.

In an embodiment of the present disclosure, the liquid feeding channel is a liquid feeding pipe connected to the cleaning assembly holder 33, namely, the liquid outlet device 36 is disposed on the cleaning assembly holder 33, and two ends of the liquid feeding pipe are communicated with the liquid supply part 70 and the liquid outlet device 36 respectively to achieve liquid supply.

Optionally, the liquid feeding channel is provided with a pump body. The cleaning liquid in the liquid supply part 70 is delivered to the liquid outlet device 36 under the action of the pump body, so that it may be ensured that the cleaning liquid has a certain impact to improve the cleaning capacity. In an embodiment of the present disclosure, a controller disposed on the base station may control such parameters as the water discharge frequency, the water discharge flow and the water discharge time of the pump body. In addition, the controller may be connected to a communication device of the base station. The communication device may control the operation of one or more elements on the base station upon receiving an instruction from the cleaning robot 10 or a remote controller, such as a computer terminal or a mobile phone app.

In an embodiment of the present disclosure, the liquid outlet device 36 may be provided with a plurality of liquid outlets 35 disposed at intervals, and the cleaning liquid may be discharged through the liquid outlets 35 and at a plurality of positions, thereby improving the cleaning efficiency.

Optionally, the liquid outlet device 36 may be integrated with the cleaning assembly holder 33, and the plurality of liquid outlets 35 are disposed at intervals on the cleaning assembly holder 33 so as to realize liquid discharge at a plurality of positions. In other embodiments of the present disclosure, the liquid outlet device 36 may also be independently disposed on the cleaning assembly holder 33 for convenient maintenance, replacement, etc.

In other embodiments of the present disclosure, the liquid outlet device 36 may be fixedly disposed on the base station body 20. For example, the liquid outlet device may include a plurality of liquid outlets 35 that are arranged from left to right along the base station body 20. When the cleaning assembly 30 moves left and right relative to the base station body 20, the liquid discharge order and the liquid discharge frequency of the liquid outlets 35 may be set according to the moving direction and the moving speed of the cleaning assembly 30 so as to guarantee that when the cleaning assembly 30 cleans the wet cleaning system 400 of the cleaning robot 10, the part to be cleaned may be wetted in advance to improve the cleaning efficiency. In addition, a water pressure adjusting device and/or a water temperature adjusting device may be provided at the liquid outlet 35 to adjust the water pressure and/or the water temperature of the liquid outlet 35 according to the dirtiness of the object to be cleaned so as to further improve the cleaning efficiency.

In other embodiments of the present disclosure, the cleaning liquid may be supplied to the cleaning assembly 13 by the liquid storage tank 13 of the cleaning robot 10. For example, in the process of cleaning the cleaning head 410 of the wet cleaning system 400 of the cleaning robot 10, the amount of water delivered by the liquid storage tank 13 to the cleaning head 410 and the time when the cleaning liquid is delivered may be realized by controlling a water pump disposed in the liquid storage tank 13 of the cleaning robot 10. In this embodiment, it is unnecessary to provide the cleaning assembly 30 with a water outlet device.

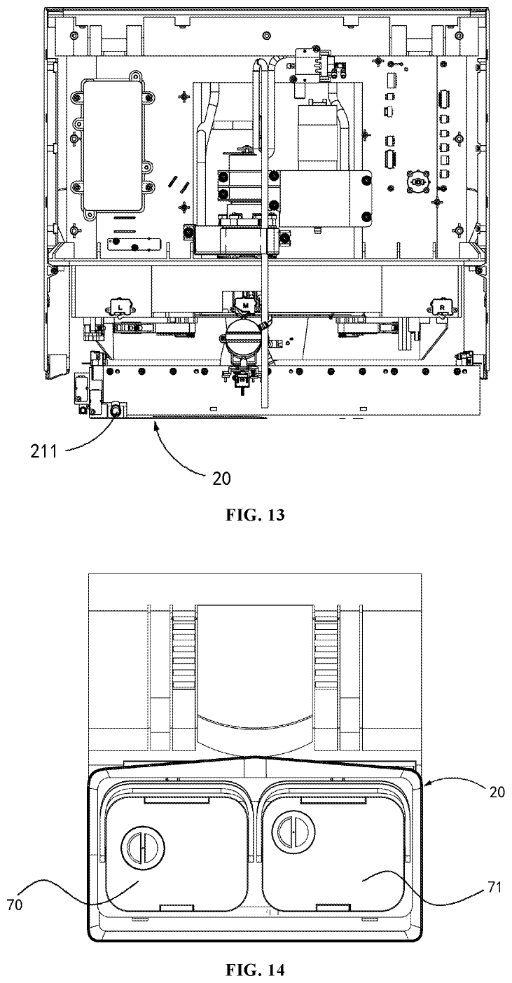

In an embodiment of the present disclosure, as shown in FIG. 13, the cleaning basin 21 disposed below the cleaning assembly 30 may be provided with a liquid extracting port 211 through which the cleaning liquid in the cleaning basin 21 may be discharged, thereby ensuring timely replacement of the cleaning liquid in the cleaning basin 21.

In an embodiment of the present disclosure, with reference to FIG. 14, the base station further includes a collection container 71 communicated with the cleaning basin 21 through the liquid extracting port 211, such that sewage in the cleaning basin 21 may flow into the collection container 71.

Specifically, with reference to FIG. 14, the base station further includes a liquid supply part 70. The liquid supply part 70 is communicated with the liquid outlet 35 by a liquid feeding pipeline and configured to supply the cleaning liquid for cleaning the cleaning system 150 of the cleaning robot 10.

In an embodiment of the present disclosure, the base station further includes a first pump body and a second pump body. The first pump body is configured to feed the cleaning liquid into the cleaning basin 21, and the second pump body is configured to pump the cleaning liquid out of the cleaning basin 21. The first pump body and the second pump body feed and pump the cleaning liquid respectively to ensure replacement of the cleaning liquid in the cleaning basin 21 and thus the cleaning effect.

The first pump body is communicated with the liquid supply part 70 to feed the cleaning liquid in the liquid supply part 70 to the cleaning basin 21 through the liquid outlet 35. The second pump body is communicated with the collection container 71 to pump the cleaning liquid in the cleaning basin 21 into the collection container 71 through the liquid extracting port 211.

In an embodiment of the present disclosure, the first pump body and the second pump body may work simultaneously. The first pump body sprays the cleaning liquid into the cleaning basin 21 and the second pump body pumps the cleaning liquid out of the cleaning basin 21, namely, the cleaning liquid flows quickly in the cleaning basin 21.

In an embodiment of the present disclosure, the first cleaning member 31 and the second cleaning member 32 constitute a cleaning member. The cleaning member may be parallel to the liquid outlet device 36. Owing to this arrangement, it may be ensured that the cleaning assembly 30 is of a compact structure which may ensure that the cleaning system 150 of the cleaning robot 10 is wetted punctually by the cleaning liquid discharged by the liquid outlet device 36 when the cleaning members perform a cleaning operation, thereby helping the cleaning member clean the cleaning system 150 of the cleaning robot 10.

It should be noted that the cleaning member is parallel to the liquid outlet device 36, namely, the cleaning member extends parallel to a straight line formed by connecting the center points of the plurality of liquid outlets 35 of the liquid outlet device 36.

In an embodiment of the present disclosure, as shown in FIG. 15A, the first cleaning member 31 is disposed on the cleaning assembly holder 33 and removes the debris from the cleaning system 150 of the cleaning robot 10 by contact with and by movement relative to the cleaning system 150. In addition, the liquid outlet 35 on the liquid outlet device 36 may be disposed toward the first cleaning member 31, and in this arrangement, the cleaning liquid discharged from the liquid outlet 35 may be first sprayed onto the first cleaning member 31, such that the first cleaning member 31 may evenly apply the cleaning liquid to the cleaning system 150 of the cleaning robot 10. In other embodiments of the present disclosure, the cleaning liquid discharged from the liquid outlet 35 may also be directly sprayed onto the cleaning system 150 of the cleaning robot 10, which is not limited by the present disclosure. In an embodiment of the present disclosure, the first cleaning member 31 may be a cleaning roller (for example, a brush roller or a soft rubber roller) that rotates around an axis parallel to the liquid outlet device 36.

In an embodiment of the present disclosure, as shown in FIG. 15A, the second cleaning member 32 is disposed on the cleaning assembly holder 33 and removes the debris from the cleaning system 150 by contact with and by movement relative to the cleaning system 150 and cooperation with the first cleaning member 31. As shown in FIG. 15A, the second cleaning member 32 is disposed at one side of the first cleaning member 31 and located above the liquid outlet device 36. In an embodiment of the present disclosure, the second cleaning member 32 may be a soft rubber scraper, etc.

In some embodiments of the present disclosure, the first cleaning member 31 and the second cleaning member 32 may be partially immersed in the cleaning liquid in the cleaning basin 21, completely immersed in the cleaning liquid, or completely not immersed in the cleaning liquid by controlling the liquid level in the cleaning basin 21.

In the case that the first cleaning member 31 and the second cleaning member 32 are partially immersed in the cleaning liquid in the cleaning basin 21, the first cleaning member 31 rotates in the reciprocating process. During the rotation, the first cleaning member 31 may take the cleaning liquid out of the cleaning basin 21 and apply it to the cleaning head 410 of the wet cleaning system 400 of the cleaning robot 10, such that the cleaning head 410 may be cleaned when the water outlet device of the base station does not work. In addition, during the reciprocating of the first cleaning member 31 and the second cleaning member 32, the debris thereon may be removed under the flushing of water flow.

In the case that the first cleaning member 31 and the second cleaning member 32 are completely immersed in the cleaning liquid in the cleaning basin 21, namely, the cleaning head 410 of the wet cleaning system 400 of the cleaning robot 10 may be immersed in the cleaning liquid in the cleaning basin 21, the cleaning head 410 may be cleaned by means of the cleaning liquid in the cleaning basin 21 when the water outlet device of the base station does not work. In addition, during the reciprocating of the first cleaning member 31 and the second cleaning member 32, the debris thereon may be removed under the flushing of water flow.

In the case that the first cleaning member 31 and the second cleaning member 32 are completely not immersed in the cleaning liquid in the cleaning basin 21, the cleaning head 410 of the wet cleaning system 400 of the cleaning robot 10 is completely cleaned by the cleaning liquid sprayed by the water outlet device of the base station, which may ensure that the cleaning head 410 may not be contaminated by the debris in the cleaning basin 21 for the second time. Therefore, this is applicable to the case that the cleaning head 410 is severely dirty or the cleaning liquid in the cleaning basin 21 has been used for many times but never replaced.

In an embodiment of the present disclosure, the liquid outlet 35 of the liquid outlet device 36 may face at least one of the first cleaning member 31 and the second cleaning member 32, such that the cleaning liquid discharged from the liquid outlet 35 may impact at least one of the first cleaning member 31 and the second cleaning member 32. That is, the liquid outlet 35 not only serves as a channel for the cleaning liquid to enter the cleaning basin 21 but also enables the water flow to impact at least one of the first cleaning member 31, the second cleaning member 32 and the cleaning head 410 of the wet cleaning system 400 of the cleaning robot 10 so as to correspondingly clean them.

In an embodiment of the present disclosure, the first cleaning member 31 and the second cleaning member 32 are disposed side by side. The liquid outlet 35 of the liquid outlet device 36 is located below the second cleaning member 32 and faces the first cleaning member 31. The liquid outlet 35 sprays the cleaning liquid in the liquid supply part 70 onto the first cleaning member 31, and interferes with the cleaning head 410 of the wet cleaning system 400 of the cleaning robot 10 by rotation of the first cleaning member so as to apply the cleaning liquid to the cleaning head 410. In other embodiments of the present disclosure, the liquid outlet 35 of the liquid outlet device 36 may discharge the liquid toward the cleaning head 410, such that the cleaning liquid may be directly sprayed onto the cleaning head 410. The cleaning head 410 is cleaned under the impact of the cleaning liquid on the cleaning head 410 and through cooperation with the first cleaning member 31 and the second cleaning member 32.

In addition, in other embodiments of the present disclosure, the liquid outlet device 36 may also be independent of the cleaning assembly 30, namely the first cleaning member 31 and the second cleaning member 32. In this way, the operation of other parts may not be influenced in the case that some parts fail to work. For example, the base station may clean the cleaning head 410 only by using the liquid outlet device 36, i.e., the cleaning head 410 may be completely cleaned under the impact of the cleaning liquid on the cleaning head 410.

In an embodiment of the present disclosure, a plurality of liquid outlets 35 may be arranged on the liquid outlet device 36. The plurality of liquid outlets 35 may work at the same time, or sequentially discharge the cleaning liquid in accordance with a preset rule, namely, the plurality of liquid outlets 35 do not discharge the cleaning liquid at the same time. For example, the water discharge times and the water discharge frequencies of the different water outlets 35 may be controlled by different water pumps or valves. In this way, the base station may be adapted to the cleaning heads 410 of different shapes and sizes. For example, part of the plurality of liquid outlets 35 may be controlled to work when the cleaning area of the cleaning head 410 is small, so as to avoid waste of the cleaning liquid.

The above descriptions mainly focus on cleaning of the cleaning head 410 of the wet cleaning system 400 of the cleaning robot 10. In other embodiments of the present disclosure, the base station may also clean other elements of the cleaning robot 10, which is not limited by the present disclosure.

In an embodiment of the present disclosure, as shown in FIGS. 11 and 12, the base station further includes a water replenishing connector 50 disposed on the base station body 20 and configured for being connected with the water replenishing inlet 16 of the liquid storage tank 13 of the cleaning robot 10 so as to inject water into the liquid storage tank 13 of the cleaning robot 10.

In an embodiment of the present disclosure, the cleaning robot 10 may move to and stop at the base station body 20, as shown in FIG. 1, for subsequent liquid replenishing.

In this embodiment, the water replenishing connector 50 of the base station may be connected to the water replenishing inlet 16 of the cleaning robot when the cleaning robot 10 moves to the base station body 20, such that the base station may supply the liquid to the liquid storage tank 13 through the water replenishing connector 50.

In an embodiment of the present disclosure, since the cleaning robot 10 may swing slightly from side to side in the process of stopping at the base station, in order to make the water replenishing connector 50 of the base station be in better alignment with the water replenishing inlet 16 of the liquid storage tank 13 of the cleaning robot 10, at least part of the water replenishing connector 50 of the base station may be movably disposed. For example, the water replenishing connector 50 is made of or disposed on a flexible material.

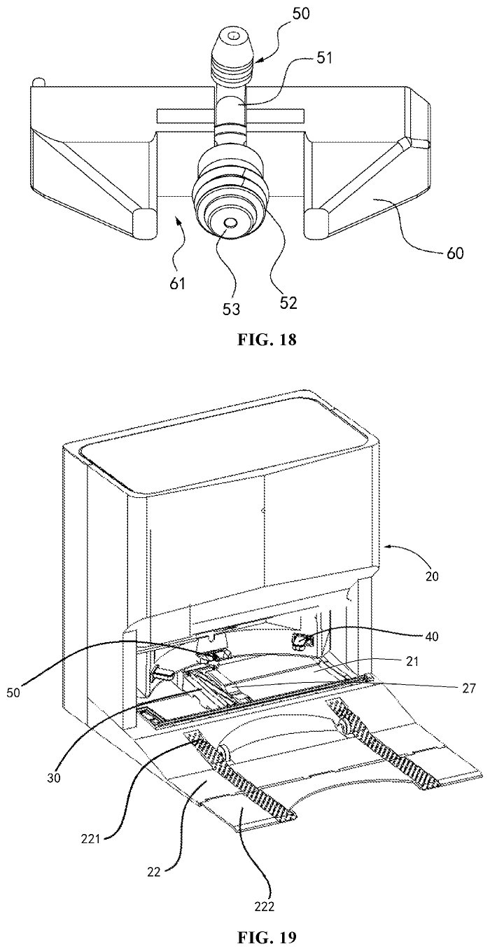

In an embodiment of the present disclosure, as shown in FIGS. 17 and 18, the water replenishing connector 50 includes: a body part 51 connected to the base station body 20; a sealing part 52 with one end connected to the body part 51; and a joint part 53 connected to the other end of the sealing part 52 away from the body part 51 and configured for being connected with the liquid storage tank 13. The sealing part 52 is made of a flexible material.

Specifically, the body part 51 is a main flowing channel of the liquid, the joint part 53 is a hard interface part for being connected with the water replenishing inlet 16 of the liquid storage tank 13 of the cleaning robot 10, and the sealing part 52 is of a soft structure. By providing the soft sealing part 52, the water replenishing connector 50 may move radially and axially to facilitate alignment with the water replenishing inlet 16 of the liquid storage tank 13.

In an embodiment of the present disclosure, as shown in FIG. 17, the water replenishing inlet 16 is configured to be adapted to the water replenishing connector 50, namely, one end of the replenishing connector 50 may be inserted into the water replenishing inlet 16, and further, the joint part 53 of the water replenishing connector 50 is inserted into the water replenishing inlet 16. As previously described, a valve (for example, a cross valve) is disposed at the water replenishing inlet 16 of the cleaning robot 10. After the water replenishing connector 50 of the base station is aligned with the water replenishing inlet 16 of the cleaning robot 10, the base station starts to add water to the liquid storage tank through the water replenishing inlet 16, and the cross valve is opened under the action of water pressure from the direction of the water replenishing connector 50, such that the water replenishing inlet 16 is communicated with the liquid storage tank 13, and the cleaning liquid flows into the liquid storage tank 13. Upon completion of water replenishing, the water pressure at the water replenishing inlet 16 from the direction of the water replenishing connector 50 disappears, and the cross valve is closed, so that the water replenishing inlet 16 is disconnected from the liquid storage tank 13, thereby preventing the cleaning liquid from flowing out of the liquid storage tank 13.

In an embodiment of the present disclosure, a forward driving force may be added to the driving wheel of the cleaning robot 10 when the cleaning robot 10 stops at the base station for adding water to the liquid storage tank 13. This is because in the process of adding water to the liquid storage tank 13, the water replenishing connector 50 of the base station may produce a rearward thrust on the cleaning robot 10 in the process of water discharging, causing the cleaning robot 10 to have a tendency to move backward. The forward driving force added to the driving wheel may offset at least part of the thrust, thereby ensuring that the cleaning robot 10 is more stable when the liquid storage tank 13 is added with water. In other embodiments of the present disclosure, whether the forward driving force is added or not, and the magnitude of the driving force, can be determined by factors such as the water discharge speed of the water replenishing connector 50, the mass of the cleaning robot 10 per se, or the friction force between the driving wheel and the stopping side of the base station when the cleaning robot 10 stops at the base station, which is not limited by present disclosure.

In order to replenish the liquid storage tank 13 of the cleaning robot 10 with the cleaning liquid punctually, a sensor may be disposed on the cleaning robot 10 to detect a change of the liquid level in the liquid storage tank 13. For example, a float containing a magnetic element may be disposed in the liquid storage tank 13 and one or more magnetic induction elements may be disposed on the liquid storage tank 13 or the body of the cleaning robot 10 to detect the change of the liquid level in the liquid storage tank 13. In the case that the liquid level in the liquid storage tank 13 is lower than a predetermined threshold, the cleaning robot 10 may automatically return to the base station for water replenishing, or remind the user via an app, voice, or the like, and the user controls the cleaning robot 10 to return to the base station for water replenishing. In other embodiments of the present disclosure, the change of the liquid level in the liquid storage tank 13 may also be detected by other means, for example, by an infrared sensor. In other embodiments of the present disclosure, the cleaning robot 10 may be controlled by other means to return to the base station for water replenishing, for example, the cleaning robot 10 may automatically return to the base station for water replenishing after completing the task of a specified cleaning area or the task of a specified region, which is not limited by the present disclosure. In addition, according to the previous text, the liquid storage tank 13 may be added with water while the cleaning head 410 of the wet cleaning system 400 of the cleaning robot 10 is cleaned.

In an embodiment of the present disclosure, as shown in FIGS. 17 and 18, the base station further includes a first positioning part 60 disposed on the base station body 20. The first positioning part 60 is configured for being connected with a second positioning part 14 on the liquid storage tank 13.

Specifically, after the cleaning robot 10 moves onto the base station body 20 and the first positioning part 60 is connected to the second positioning part 14, the water replenishing connector 50 is connected to the liquid storage tank 13. At this time, the liquid storage tank 13 may be added with the liquid through the water replenishing connector 50.

In an embodiment of the present disclosure, as shown in FIG. 18, the first positioning part 60 is provided with an accommodating space 61, and the end of the water replenishing connector 50 for being connected with the liquid storage tank 13 is located in the accommodating space 61. In the case that the first positioning part 60 and the second positioning part 14 are connected, the water replenishing connector 50 located in the accommodating space 61 may be reliably connected to the water replenishing inlet 16 of the liquid storage tank 13.

In an embodiment of the present disclosure, as shown in FIG. 17, the second positioning part 14 is a groove for fitting the first positioning part 60. That is, the first positioning part 60 is inserted into the groove, so that the water replenishing connector 50 is reliably connected to the water replenishing inlet 16. The outer surface of the first positioning part 60 may be beveled to facilitate insertion into the groove, and the first positioning part 60 may also be introduced into the second positioning part 14 in the event that the cleaning robot 10 and the base station body 20 are not perfectly aligned with each other.

In an embodiment of the present disclosure, the liquid supply part 70 may be communicated with the water replenishing connector 50 and supplies the liquid to the liquid storage tank 13 via the water replenishing connector 50. The liquid supply part 70 is configured to accommodate the cleaning liquid, and the liquid in the liquid supply part 70 may be fed into the liquid storage tank 13 via the water replenishing connector 50.

Optionally, the liquid supply part 70 is selectively communicated with the water replenishing connector 50 or the liquid outlet 35, namely, the liquid supply part 70 may replenish the liquid storage tank 13 with the liquid through the water replenishing connector 50, or the liquid supply part 70 may feed the cleaning liquid into the cleaning basin 21 through the liquid outlet 35 of the liquid outlet device 36. The first pump body is configured to feed the cleaning liquid into the cleaning basin 21, or the first pump body is configured to feed the liquid into the water replenishing connector 50 so as to replenish the liquid storage tank 13 with the liquid.

It should be noted that the liquid discharged by the liquid supply part 70 may flow into two channels, one of which is communicated with the water replenishing connector 50 and the other of which is communicated with the liquid outlet 35. The liquid supply part 70 may be selectively communicated with the two channels so as to control the delivery of liquid to the water replenishing connector 50 or the liquid outlet 35. Valves may be disposed on the two channels respectively, and the communication and disconnection of the two channels may be controlled by controlling opening and closing of the valves. Or there may be one three-way valve, for example, an electromagnetic valve, namely, the liquid supply part 70 may be controlled to be communicated with the corresponding channel by providing the electromagnetic valve.

As shown in FIGS. 11 and 12, the base station further includes a second charging contactor 40. The second charging contactor 40 is configured for being electrically connected with the first charging contactor 12 of the cleaning robot 10 to enable the base station to charge the cleaning robot 10. As shown in FIG. 2, the second charging contactor 40 is electrically connected to the first charging contactor 12 when the cleaning robot 10 stops at the base station.

In some embodiments, as shown in FIG. 12, the base station body 20 further includes a side guiding surface 23. The second charging contactor 40 is disposed on the side guiding surface 23 while the first charging contactor 12 is disposed on a lateral surface of the cleaning robot 10, such that the second charging contactor 40 may be electrically connected to the first charging contactor 12.

In some embodiments, as shown in FIG. 12, the side guiding surface 23 includes two opposing lateral surfaces 231 and a middle surface 232 disposed between the two lateral surfaces 231. The middle surface 232 faces a direction, in which the cleaning robot 10 moves onto the base station. The second charging contactor 40 is disposed on the middle surface 232, namely, the first charging contactor 12 is disposed on the end side surface of the cleaning robot 10.

In an embodiment of the present disclosure, the plurality of second charging contactors 40 and the plurality of first charging contactors 12 are provided in pairs. Optionally, the second charging contactors 40 may also be located on the lateral surfaces 231, namely, the two second charging contactors 40 in pairs may be located on the two lateral surfaces 231 respectively.

Correspondingly, in an embodiment of the present disclosure, the first charging contactor 12 disposed on the cleaning robot 10 may be disposed on the front side surface of the cleaning robot 10. As shown in FIG. 21, a forward portion of the cleaning robot 10 is provided with a buffer 122, which is movably disposed on the body of the cleaning robot 10. When the cleaning robot 10 encounters an obstacle in front during movement, the buffer 122 may collide with the obstacle and move toward the body of the cleaning robot 10; and after the cleaning robot 10 passes over the obstacle, the buffer 122 moves away from the body of the cleaning robot 10. Therefore, during the operation of the cleaning robot 10, the buffer 122 may be in a state of constant compression and expansion. In an embodiment of the present disclosure, the first charging contactor 12 of the cleaning robot 10 is disposed on the body of the cleaning robot 10 at the rear of the buffer 122, and a through hole 1221 is formed in a corresponding portion of the buffer 122, such that the first charging contactor 12 may be in contact with the second charging contactor 40 during charging of the cleaning robot 10. The first charging contactor 12 is disposed at the rear of the buffer 122 and thus prevented from being directly exposed outside the cleaning robot body. Therefore, the following situation is avoided: the first charging contactor 12 is subjected to frictional damage caused when the cleaning robot 10 collides with a hard obstacle.

In an embodiment of the present disclosure, the first charging contactor 12 and the wet cleaning system 400 of the cleaning robot 10 are located on two opposite sides of the cleaning robot 10 respectively, i.e., at a front end and a rear end of the cleaning robot 10 in a travelling direction. Specifically, the first charging contactor 12 is located on the front side of the cleaning robot 10 and the wet cleaning system 400 is located on the rear side of the cleaning robot 10. Therefore, in an embodiment of the present disclosure, the cleaning robot 10 may stop at the base station with two postures. The cleaning robot 10 moves forward to stop at the base station when the cleaning robot 10 returns to the base station for being charged; and the cleaning robot 10 moves backward to stop at the base station when the wet cleaning system 400 of the cleaning robot 10 is cleaned or water is added to the liquid storage tank 13. In order to cooperate with the two operation modes, elements communicating with the base station may be disposed in the front and at the rear of the cleaning robot 10, for example, infrared devices for receiving signals from the base station may be disposed in the front and at the rear of the cleaning robot 10, which is not limited by the present disclosure.

In an embodiment of the present disclosure, as shown in FIG. 19, the base station may further include a guiding bridge 27, which is disposed above the cleaning basin 21 and configured to support a driven wheel 142 of the cleaning robot 10. As shown in FIG. 4, the driven wheel 142 is disposed in the front of the bottom of the cleaning robot 10. In order to keep the cleaning robot 10 stable when the cleaning robot 10 stops at the base station for being charged, a holder, i.e., the guiding bridge 27, may be disposed below the driven wheel 142. As shown in FIG. 19, the guiding bridge 27 in this embodiment spans the front end and the rear end of the cleaning basin 21, may lead the driven wheel 142 to pass and may play a support role after the cleaning robot 10 stops. In other embodiments of the present disclosure, a broken bridge extending forward may be disposed only at the front end portion of the cleaning basin, and its extension length may be determined based on the stop position of the cleaning robot 10, the disposing position of the driven wheel 142, and other factors, which is not limited by the present disclosure. In an embodiment of the present disclosure, since the cleaning assembly 30 capable of reciprocating left and right is disposed above the cleaning basin, the guiding bridge 27 may be movably disposed above the cleaning basin 21 to prevent the guiding bridge 27 from obstructing the movement of the cleaning assembly 30. For example, when the cleaning robot 10 stops at the base station for being charged, the guiding bridge 27 may be moved to the middle portion of the cleaning basin 21 to guide and support the driven wheel 142 of the cleaning robot 10; and when the cleaning robot 10 stops at the base station for cleaning the cleaning head 410 of the wet cleaning system 400, the guiding bridge 27 may be moved to one side of the cleaning basin 21 such that the cleaning assembly 30 may move left and right. In an embodiment of the present disclosure, as shown in FIG. 19, the guiding bridge 27 and the cleaning assembly 30 may be disposed on the same holder and driven by the same driving part to move left and right. In this way, the components may be arranged more compactly, and thus the space of the base station may be effectively utilized.

In an embodiment of the present disclosure, as shown in FIG. 19, the base station body 20 further includes a bottom guiding surface 22 with an anti-skid bulge 221 disposed thereon. The cleaning robot 10 moves onto the bottom guiding surface 22 along the anti-skid bulge 221. The anti-skid bulge 221 may produce a certain friction force with the cleaning robot 10 to ensure that the cleaning robot 10 moves reliably to the base station body 20. Moreover, the anti-skid bulge 221 may assist the cleaning robot 10 in positioning during the cleaning.

In an embodiment of the present disclosure, the cleaning assembly 30 is located above the bottom guiding surface 22, and spaced apart from the anti-skid bulge 221, such that after the cleaning robot 10 moves on the bottom guiding surface 22 for a certain distance, the cleaning assembly 30 is arranged opposite to the cleaning system 150 for the subsequent cleaning process.

Optionally, the cleaning basin 21 is disposed on the bottom guiding surface 22, and the bottom guiding surface 22 includes an inclined surface on which the anti-skid bulge 221 may be disposed and a flat surface on which the cleaning basin 21 may be disposed.

It should be noted that an anti-skid structure formed by the anti-skid bulge 221 corresponds to a walking wheel assembly of the cleaning robot 10, and there are two anti-skid structures when there are two walking wheel assemblies.

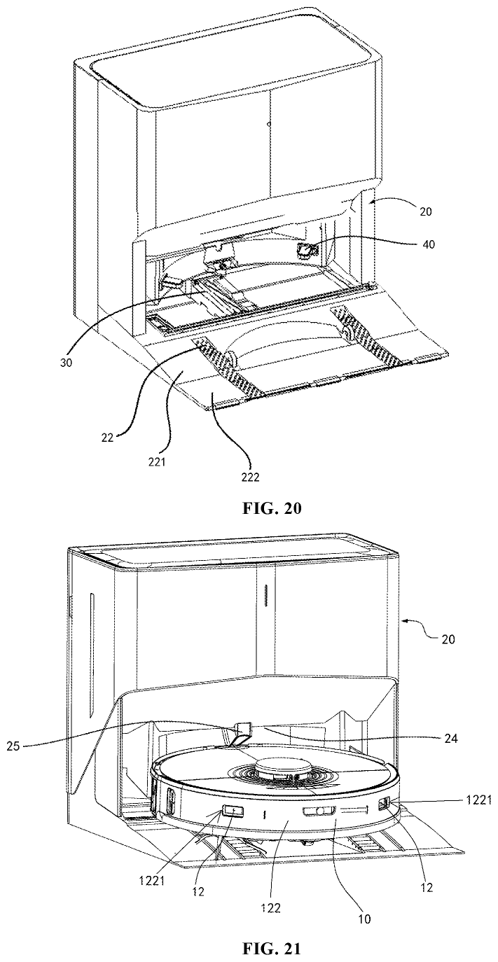

In an embodiment of the present disclosure, as shown in FIGS. 19 and 20, the base station body 20 is provided with a lengthening plate 222, which is connected to an end of the base station body 20 to assist the cleaning robot 10 in moving onto the base station body 20. The lengthening plate 222 is foldably provided, i.e., may be stacked on the bottom guiding surface 22. Under special circumstances, for example, a slippery floor, the lengthening plate 222 may be unfolded to facilitate climbing of the cleaning robot 10.

In an embodiment of the present disclosure, the base station body 20 further includes a top guiding surface 24 with a guiding part disposed thereon, and the guiding part is configured to be in contact with the cleaning robot 10. The guiding part is located above the cleaning assembly 30, may limit the cleaning robot 10 and thus ensure that the cleaning robot 10 moves to an appropriate position.

Specifically, the guiding part is located above the cleaning assembly 30, i.e., the cleaning assembly 30 is located on the bottom guiding surface 22, while the guiding part is located on the top guiding surface 24. The guiding part is located above the cleaning assembly 30 when viewing in a height direction.

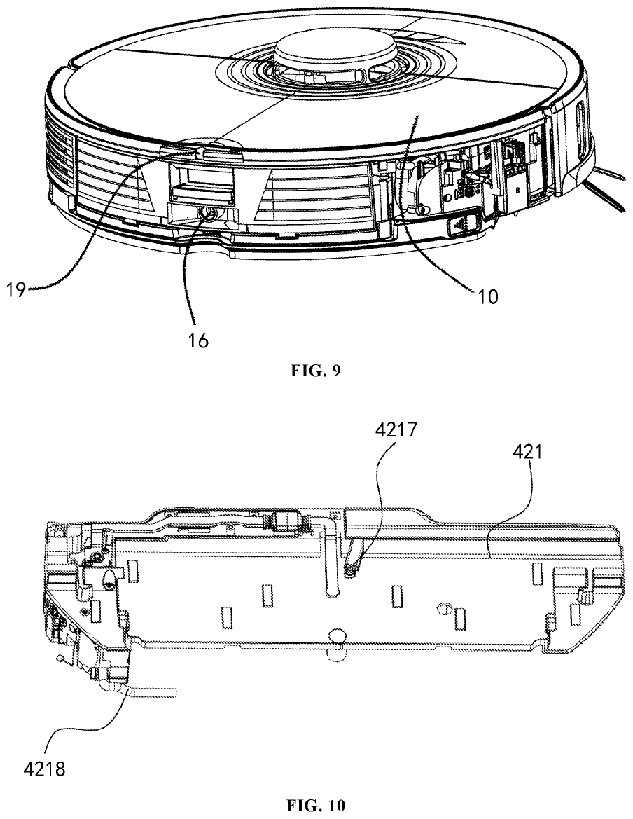

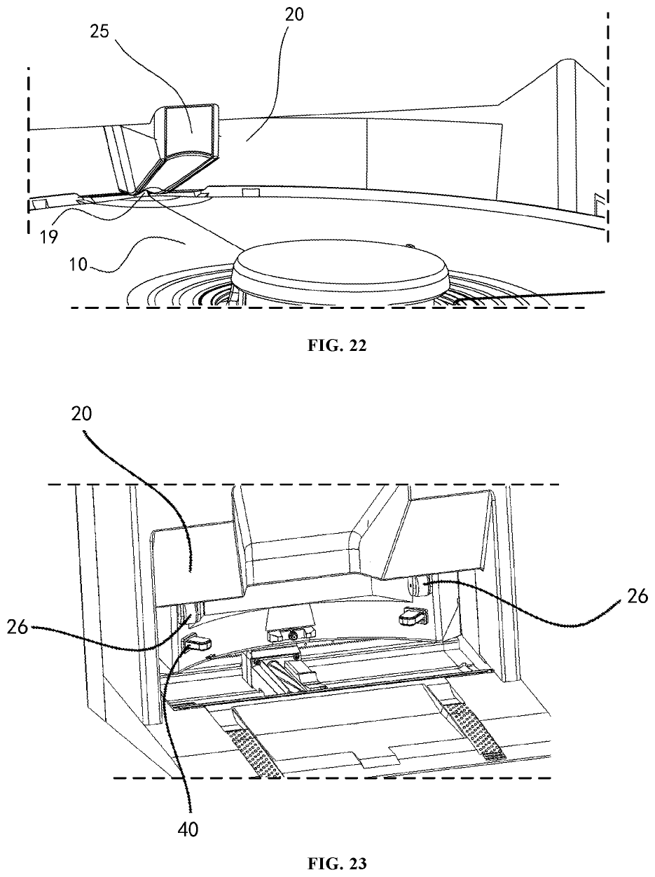

In an embodiment of the present disclosure, as shown in FIGS. 21 and 22, the guiding part may include a guiding press block 25, and a rotary wheel 19 is disposed on an upper side edge of the cleaning robot 10. As shown in FIG. 9, the rotary wheel 19 may rotate along an axis perpendicular to the moving direction of the cleaning robot 10. When the cleaning robot 10 needs to move to the base station body 20, the rotary wheel 19 may cooperate with the guiding press block 25 to help the cleaning robot 10 move onto the base station body 20 more smoothly.

In an embodiment of the present disclosure, as shown in FIG. 23, the guiding part may include a guiding wheel 26, which, in addition to assisting the cleaning robot 10 in moving onto the base station body 20, may also limit the movement of the cleaning robot 10 in the vertical direction after the cleaning robot 10 stops at the base station body 20. For example, when the cleaning robot 10 stops at the base station body 20 for cleaning, the cleaning assembly 30 of the base station is in contact with the cleaning head 410 of the wet cleaning system 400 of the cleaning robot 10 and applies a vertically upward thrust to the cleaning robot 10, and the guiding wheel 26 may be provided to partially or fully offset the vertically upward thrust so as to prevent the cleaning robot 10 from moving upward. Optionally, there may be at least two guiding wheels 26 symmetrically disposed on the left side and the right side of the base station.

The base station in this embodiment may clean the cleaning robot, replenish the liquid storage tank of the cleaning robot with the liquid, and charge the cleaning robot.

Other embodiments of the present disclosure will be apparent to those skilled in the art from consideration of the description and practice of the present disclosure here. The present disclosure is intended to cover any variations, uses, or adaptations of the present disclosure following the general principles of the present disclosure and including common knowledge or customary technical means in the technical field which are not disclosed in the present disclosure. The description and the exemplary embodiments are to be considered as exemplary only, with a true scope and spirit of the present disclosure indicated by the foregoing claims.

It should be understood that the present disclosure is not limited to the exact structure that has been described above and illustrated in the accompanying drawings, and that various modifications and changes can be made without departing from the scope of the present disclosure. It is intended that the scope of the present disclosure is only limited by the appended claims.

What is claimed is:

1. A base station for maintaining a cleaning robot, comprising:
a base station body comprising a cleaning basin;
a cleaning assembly, disposed in the cleaning basin, and configured to clean a cleaning pad of the cleaning robot through a relative motion in a substantial horizontal plane between the cleaning assembly and the cleaning pad, wherein the cleaning pad is operable to move between a first position and a second position lower than the first position;
a liquid storage container, disposed on the base station body and above the cleaning assembly, and configured to supply liquid to a liquid storage tank of the cleaning robot;
a collection container, disposed on the base station body and above the cleaning assembly, and configured to collect liquid from the cleaning basin.

2. The base station according to claim 1, wherein the cleaning assembly cleans the cleaning pad of the cleaning robot when the cleaning pad is in the second position.

3. The base station according to claim 1, wherein the cleaning assembly cleans the cleaning pad of the cleaning robot when the cleaning pad moves relative to the base station.

4. The base station according to claim 1, wherein the liquid storage container is further configured to supply liquid for cleaning the cleaning pad of the cleaning robot.

5. The base station according to claim 1, further comprising an arcuate inner bay at least partially housing the cleaning robot during maintaining the cleaning robot.

6. The base station according to claim 5, further comprising a liquid injection nozzle, connected to the liquid storage container, and configured to inject the liquid in the liquid storage container to the liquid storage tank of the cleaning robot, wherein the liquid injection nozzle is movably disposed on a side wall of the arc inner bay.

7. The base station according to claim 6, further comprising at least one second guider, disposed on the side wall of the arcuate inner bay, and configured to incorporate to a first guider disposed on the cleaning robot to facilitate a liquid filling port connected to the liquid storage tank aligning to the liquid injection nozzle.

8. The base station according to claim 7, wherein in a case that there are two second guiders, the two second guiders are symmetrically disposed on a left side and a right side of the liquid injection nozzle respectively.

9. The base station according to claim 8, wherein the liquid injection nozzle is wrapped with a flexible seal.

10. The base station according to claim 5, wherein the arcuate inner bay houses a rear portion of the cleaning robot when the cleaning assembly cleans the cleaning pad of the cleaning robot or the liquid storage container supplies the liquid to the liquid storage tank of the cleaning robot.

11. A cleaning robot, comprising:
a robot body;
a driving system, disposed to the robot body, and configured to drive the cleaning robot across a floor surface;
a cleaning pad, disposed to the robot body, and configured to clean the floor surface, wherein the cleaning pad is operable to move between a first position and a second position lower than the first position, and the cleaning pad is cleaned by a cleaning assembly of a base station through a relative motion in a substantial horizontal plane between the cleaning assembly and the cleaning pad;
a liquid storage tank, disposed above the cleaning pad, and configured to supply liquid to the cleaning pad and be filled by a liquid storage container of the base station.

12. The cleaning robot according to claim 11, wherein the cleaning pad is cleaned when the cleaning pad is in the second position.

13. The cleaning robot according to claim 11, wherein the cleaning pad is cleaned when the cleaning pad moves relative to the base station.

14. The cleaning robot according to claim 11, wherein the cleaning robot has a substantially round perimeter, and the cleaning robot is partially housed by an arcuate inner bay of the base station when the base station maintains the cleaning robot.

15. The cleaning robot according to claim 14, wherein a rear portion of the cleaning robot is housed by the arcuate inner bay of the base station when the base station cleans the cleaning pad of the or the base station supplies liquid to the liquid storage tank.

16. A cleaning robot system, comprising a base station and a cleaning robot,
wherein the base station comprises:
a base station body comprising a cleaning basin;
a cleaning assembly, disposed in the base station body, and configured to clean a cleaning pad of the cleaning robot through a relative motion in a substantial horizontal plane between the cleaning assembly and the cleaning pad;
a liquid storage container, disposed on the base station body and above the cleaning assembly, and configured to supply liquid to a liquid storage tank of the cleaning robot;
a collection container, disposed on the base station body and above the cleaning assembly, and configured to collect liquid from the cleaning basin;
wherein the cleaning robot comprises:
a robot body;
a driving system, disposed to the robot body, and configured to drive the cleaning robot across a floor surface;
the cleaning pad, disposed to the robot body, and configured to clean the floor surface, wherein the cleaning pad is operable to move between a first position and a second position lower than the first position;
the liquid storage tank, disposed above the cleaning pad, and configured to supply liquid to the cleaning pad and be filled by the liquid storage container;
a control module, communicated with the driving system, the cleaning pad and the liquid storage tank, and configured to:
control the driving system to automatically move the cleaning robot on the floor surface;
control the cleaning pad to move between the first position and the second position; and
control the liquid storage tank to automatically supply the liquid to the cleaning pad for cleaning the floor surface.
